(19) United States
(12) Patent Application Publication
(10) Pub. No.: US 2011/0044124 A1
(43) Pub. Date: Feb. 24, 2011

(54) BONE CEMENT MIXER

(76) Inventors: Giovanni Faccioli, Monzambano (Mantova) (IT); Renzo Soffiatti, Nogara (IT)

Correspondence Address: TUTUNJIAN & BITETTO, P.C., 425 Broadhollow Road, Suite 302, Melville, NY, 11747, US

(21) Appl. No.: 12/544,326

(22) Filed: Aug. 20, 2009

(51) Int. Cl. B01F 11/00; B01F 15/02

(52) U.S. Cl. 366/114; 366/130

(57) ABSTRACT

Mixer for obtaining bone cement for medical applications comprising a mixing chamber in which the mixing of at least two components which form the cement is carried out, comprising means for generating and transmitting vibrations to the mixing chamber and a luer attachment through which the cement can exit.

The invention refers to a bone cement mixer.

In surgery, bone cement is very often used for the reconstruction of bones.

It is normally prepared through two components, one liquid (monomer) and one in powder (polymer), kept separate from one another right until they are mixed at which point they bond together. The mixing is carried out when the worker pours the liquid component into the container with the powder to form a cement-like mixture.

It is preferable to mix the two components in closed containers, in order to avoid diffusion of vapours. These containers are usually equipped with a mixer member, usually a piston or a spatula which can be actuated manually. The cement is then transferred and injected onto the bone through a syringe.

It is a trend for surgeons to search for ever more dense cement, because they are more easily applied whilst having a lower tendency to leak inside the body. However, having a higher density requires more strength while mixing, and therefore there is the parallel problem of suitably mixing the two cement components without excessive strain.

The object of the invention is that of making the aforementioned mixing of the cement in medical devices easier obtaining it through “knocking or vibration” applied to the walls of the mixer.

Such an object is obtained with a mixer for forming bone cement for medical applications comprising a mixing chamber in which the mixing between at least two components which form the cement can be carried out, the chamber being defined by walls of the mixer, characterized in that it comprises means for generating and transmitting vibrations at the outer side of at least one wall of the mixing chamber.

The generating and transmitting means can be made in many ways.

An electric energy vibration generator can be used, like for example an eccentric fitted onto an electric motor in abutment against a wall of the mixing chamber. Power can be supplied, for example, through batteries integrated in the mixer. Otherwise, the shaking movement which is given to the mixer by the worker during the mixing could be exploited. In this case it is advantageous to make the means for generating and transmitting vibrations having a mass free to oscillate (knocker) and knock against an outer side of at least one wall of the mixing chamber.

The free mass can be a sphere or in general a body fixedly connected to the mixer, for example, by a cable. Or the mass can be contained inside a closed chamber which shares a wall with the mixing chamber, thus improving its integration with the mixer and making it more compact.

In order to increase the effectiveness of the knocking mass, the shared wall between said closed chamber and said mixing chamber is equipped with thinner portions to favour a sussultatory movement of the shared wall itself. The rigidity of the shared wall is thus reduced increasing the bending capacity thereof and further moving the forming cement.

The invention also solves the coupling problem of the mixer with the device used to inject the cement into the bone, usually a syringe or a press dispenser.

The mixer should have a structure able to prevent contamination of the cement from the environment and make the application and use operations in the operating room easier.

For this purpose, the invention providing the mixer with a luer fitting through which the cement can exit, the luer fitting being easily coupled with a syringe and/or dosage tubes. Preferably the mixer comprises a luer cap for the luer fitting.

Further characteristics and advantages of the invention shall become clearer from the description given as an example of a mixer, together with the attached drawings in which:

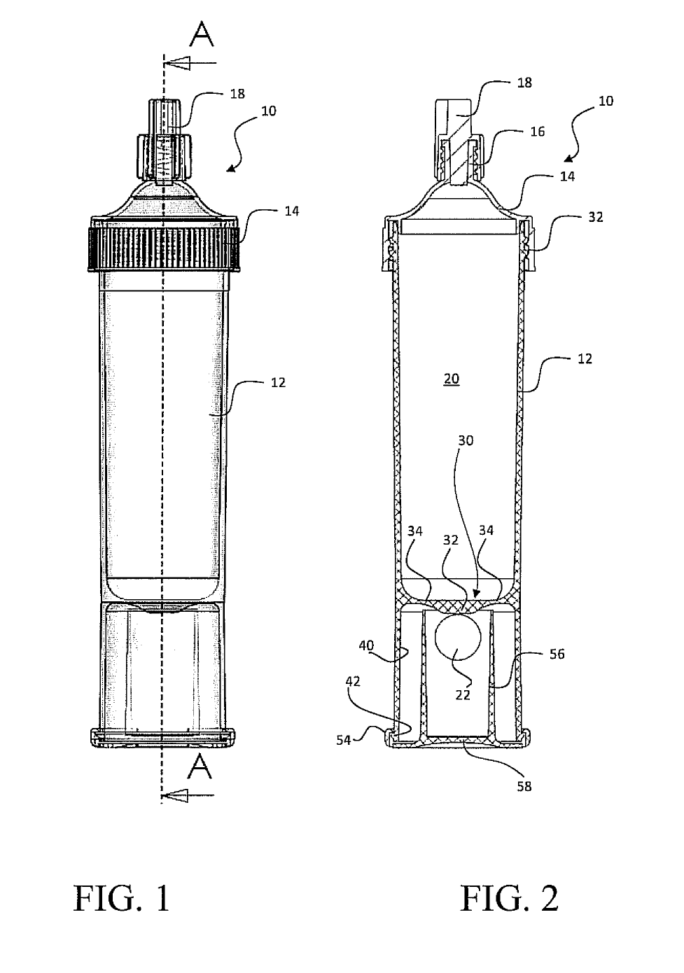

FIG. 1 shows a side view of a mixer according to the invention;

FIG. 2 shows a section view of the mixer of FIG. 1 according to the plane A-A of FIG. 1;

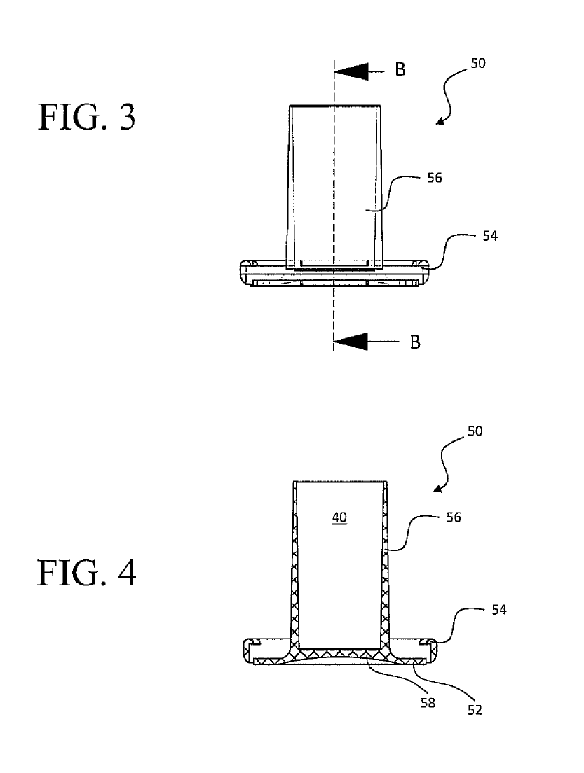

FIG. 3 shows a side view of a component of the mixer of FIG. 1;

FIG. 4 shows a section view of the component of FIG. 3 according to the plane B-B of FIG. 3;

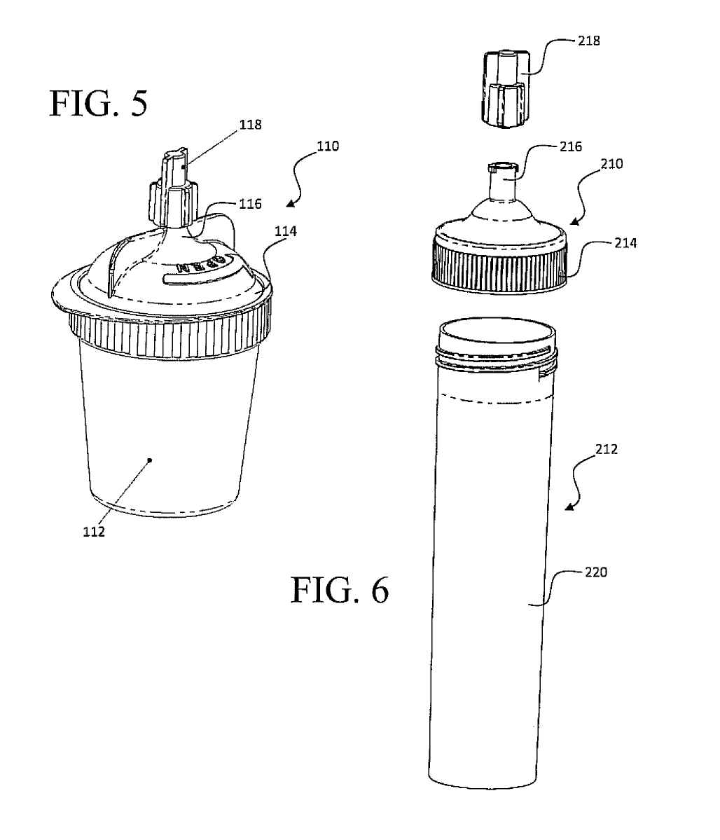

FIG. 5 shows a side view of a second mixer according to the invention;

FIG. 6 shows a side view of a second mixer according to the invention.

A mixer according to the invention is indicated with reference numeral 10.

Said mixer comprises a cylindrical case 12 which extends along an axis X and which defines a mixing chamber 20 inside of it, and another open chamber 40 adjacent to the first one and with which it shares a common wall 30.

The mixing chamber 20 is open towards the outside and at the corresponding end of the mixer 10, on its outer side surface, there is a thread 32 onto which a lid 14 can be screwed to close the chamber, forming one of its walls. (see FIG. 2). Once the components to be mixed have been deposited in the chamber 20, the cap 14 is applied and closed. The lid 14 is tapered and has a luer fitting opening 16 at its apex, closed by a luer cap 18.

A closing element 50 can be inserted snapping into the chamber 40 (see FIGS. 3 and 4). The closing element comprises a circular base 52 and a hollow cylindrical central body 56 open at one end and closed at the bottom 58. The base 52 has a peripheral lip 54 suitable for snapping onto an edge in relief 42 on the outside of the case 12. Inside the body 56 there is a small sphere 22, smaller in size, which is free to move inside of the body and to knock against its walls.

The chamber 40 has an oblong shape and a depth almost equal to the height of the body 56, so that the second one can be inserted into the first (FIG. 3). It should be seen that the small sphere 22 can substantially move with a good clearance from and towards the wall 30 (along the axis X) staying within the body 56.

The section of the wall 30 is not even. It has a central portion 32 which is thicker and an annular portion 34 which is thinner. In this way the ability of the portion 32 to oscillate with respect to the case 12 is increased.

The operation of the mixer 10 is as follows. The element 50 is applied to the mixer 10 and the components to be mixed are introduced into the chamber 20, after closing it with the lid 14. Then the mixer 10 should be held in hand and shaken. Consequently, the small sphere 22 is set in motion inside the chamber 40 and repeatedly knocks against the wall 30. The mixing of the components is obtained thanks to manual shaking, and a further mixing effect is developed through the vibrations generated by the impact of the sphere 22 against the wall 30. Even though the cement has high density, such vibrations are unexpectedly able to improve the mixing.

It should also be noted that the funnel-shaped hermetically sealing lid 14 ends with a luer fitting 16, which allows a syringe to be connected to it and thus directly aspirate the mixed cement. This means there is an optimal asepticity of the cement. The luer cap 18 further improves the characteristics of adaptability and simplicity of use of the mixer 10.

The solution with luer fitting can be implemented to other mixers as well, with or without knocking mass. FIGS. 5 and 6 show some examples, the first one is of a cup mixer 110 which comprises a cylindrical case 112 and which defines a mixing chamber inside of it. Such a mixing chamber is open towards the outside and it is closed by a tapered lid 114 which has a luer fitting 116 at its apex, and it is closed by a luer cap 118.

The second mixer 210 comprises a cylindrical case 212 and it defines a mixing chamber 220 inside of it. Such a mixing chamber is open towards the outside and it is closed by a tapered lid 214 which has a luer attachment 216 at its apex and it is closed by a luer cap 218.

1. Mixer for obtaining bone cement for medical applications comprising
A mixing chamber wherein the mixing of at least two components which form the cement can be carried out, the chamber being defined by walls of the mixer,
Characterized in that it comprises
means for generating and transmitting vibrations to the outer side of at least one wall of the mixing chamber.

2. Mixer according to claim 1, wherein the means for generating and transmitting vibrations comprise a mass free to oscillate and knock against an outer side of at least one wall of the mixing chamber.

3. Mixer according to claim 2, wherein said mass is contained inside a closed chamber which shares a common wall with the mixing chamber.

4. Mixer according to claim 3, comprising a main body which defines the mixing chamber and an element able to be permanently coupled with the main body, the element having a cavity, in which said mass can move, that has an opening, from which said mass can exit, which, once coupled, faces towards the common wall.

5. Mixer according to claim 3, wherein the common wall between said closed chamber and said mixing chamber has thinner portions to favour a sussultatory movement of the shared wall itself.

6. Mixer according to claim 1, comprising a Luer fitting through which the cement can exit.

7. Mixer according to claim 6, comprising a Luer cap for the Luer fitting.

8. Mixer for obtaining bone cement for medical applications comprising
A mixing chamber wherein the mixing of at least two components which form the cement can be carried out, the chamber being defined by walls of the mixer,
Characterized in that it comprises
a Luer fitting through which the cement can exit.

9. Mixer according to claim 8, comprising a Luer cap for the Luer fitting.

10. Mixer according to claim 8, comprising means for generating and transmitting vibrations to the outer side of at least one wall of the mixing chamber.

11. Mixer according to any claims 8 to 10, wherein the means for generating and transmitting vibrations comprise a mass free to oscillate and knock against an outer side of at least one wall of the mixing chamber.

12. Mixer according to claim 11, wherein said mass is contained inside a closed chamber which shares a common wall with the mixing chamber.

13. Mixer according to claim 12, comprising a main body which defines the mixing chamber and an element able to be permanently coupled with the main body, the element having a cavity, in which said mass can move, that has an opening, from which said mass can exit, which, once coupled, faces towards the common wall.

14. Mixer according to claim 12, wherein the common wall between said closed chamber and said mixing chamber has thinner portions to favour a sussultatory movement of the shared wall itself.
